(19) United States
(12) Patent Application Publication
(10) Pub. No.: US 2013/0115969 A1
(43) Pub. Date: May 9, 2013

(54) SYSTEM AND METHOD FOR CELL PHONE TARGETING AND TRACKING

(71) Applicants: Fred H. Holmes, Cleveland, OK (US); Kevin C. Baxter, Glendale, CA (US); Scott M. Manderville, Georgetown, IN (US)

(72) Inventors: Fred H. Holmes, Cleveland, OK (US); Kevin C. Baxter, Glendale, CA (US); Scott M. Manderville, Georgetown, IN (US)

(21) Appl. No.: 13/460,383

(22) Filed: Apr. 30, 2012

Related U.S. Application Data
(60) Provisional application No. 61/480,338, filed on Apr. 28, 2011.
(60) Provisional application No. 61/535,304, filed on Sep. 15, 2011.

(51) Int. Cl. H04W 4/04

(52) U.S. Cl. CPC H04W 4/04
USPC 455/456.1

(57) ABSTRACT

In one preferred embodiment the present invention will provide a system and method for tracking a plurality of user cell phones within a defined coverage area, including indoor areas of a buildings and/or within sub-surface structures. Such a system will include: at least one cell phone located within a predefined coverage area; a direction finding receiver, comprising a plurality of sensors, for receiving transmissions from the cell phone; and a location server for calculating the position and tracking movement of the cell phone. In another preferred embodiment, the inventive system will further comprise at least one local cell through which the tracked cell phone communicates with a cellular phone network.

### CROSS REFERENCE TO RELATED APPLICATION

This application claims the benefit of U.S. Provisional Application No. 61/480,338 filed Apr. 28, 2011, and U.S. Provisional Application No. 61/535,304 filed on Sep. 15, 2011, herein fully incorporated by reference for all purposes.

### FIELD OF THE INVENTION

The present invention relates to a system and method for tracking people and mobile equipment over a defined area. More particularly, but not by way of limitation, the present invention relates to a system for tracking individuals, items, and vehicles within a predetermined coverage area via a conventional cell phone, a cell phone based equipment tag, or vehicle-mounted transceiver.

### BACKGROUND OF THE INVENTION

Present day tracking systems can be divided broadly into four categories: 1) those where a sensor determines its own position and transmits its position to the tracking system; 2) those where a transmitter is placed on the object to be tracked and the tracking system use direction finding techniques to track the transmitter; 3) video surveillance systems that track a target through the covered area; and 4) hybrid systems that employee two, or all three, of these techniques.

Presently outdoor tracking of people and vehicles is relatively easy using GPS-based devices and a number of products exist for such purposes. Some of these systems even include inertial platforms for maintaining relatively accurate position information during brief periods of time when a usable GPS signal cannot be sensed. Inertial systems are well known in the art and typically include some combination of gyroscopes and accelerometers along with sensors for augmenting position and attitude such as magnetometers, barometric sensors, speedometers, and the like. Augmentation refers to correcting the effects of drift which arise from inaccurate measurements and the effect of zero-offset on integrating rate information from gyros into angular position and integrating accelerometer information into velocity and positional information. In general, GPS tracking systems are designed to work over relative large geographic areas, have limited accuracy, and perform poorly indoors. However, in almost every case such systems suffer increasingly inaccurate location determination the longer a tracked target remains indoors.

Other examples of tracking systems include those associated with cell phones to meet the requirements of E-911 systems when reporting the phone user's position during an emergency call. Of course, with these systems the positional information is only required to be accurate to within 300 meters. Additionally, typically such systems also work over a large area and are not intended to provide accurate position information within a confined space or in a building. To accomplish positional measurement, cell phone companies employ a number of diverse techniques to determine a position such as: triangulating from azimuthal information from two or more cell towers; determining an angular position and time-of-flight for transmissions to a single tower; requiring phones to report their GPS positions; estimating position from relative signal strengths from several antennas; or mapping signatures of relative signal strengths from reference transmitters and using the signature data to estimate a phone's position from the signature map.

Many of the newer smart phones include accelerometers. Some phones additionally include magnetometers, and some even include gyros. As with all inertial systems, without augmentation such phones cannot maintain accurate positional information. Augmentation for these sorts of devices typically takes the form of reference to a restoring signal, e.g. a GPS position.

By way of example, in radar counter measure systems direction finding schemes are used to locate the source position of radar installations. Such schemes include, but are not limited to: scanning by rotating a directional antenna, either electronically or mechanically; using Doppler shift techniques, by rotating an array of antenna, not necessarily directional antenna, and measuring the Doppler shift to determine an angle of arrival; applying the Watson-Watt method using amplitude comparison from four omnidirectional antenna mounted in a circle at 90 degree intervals; using directional antennas to determine an azimuthal direction to the target radar; using difference time of arrival from three or more antenna; or using an interferometer to determine an angle of arrival from the relative phase angles of the received signals at several antenna located in a known array.

Obviously, schemes that only determine an angle of arrival require at least two sensors at geographically spaced apart locations to determine a position by finding the intersection of the two radials. Further, systems that require scanning or rotation may not work well on pulsed or transient signals. In other words, these systems work best on CW, or continuous wave, transmissions. In contrast, difference time of arrival systems only work well on pulsed or transient signals, and only work well for CW transmissions if the beginning or end of the transmission is identifiable at several locations. Of the various schemes, interferometry provides the best performance over diverse transmission types and over fairly broad bandwidth, while capable of relatively good accuracy, typically well under one degree. Unfortunately, interferometry is affected by multipath interference and thus, its application in highly reflective environments, such as indoors, is problematic.

Yet another example of a technique that is used to track a cell phone simply involves using a base station with a limited coverage area to provide an indication that the cell phone is proximate to that base station. Very low power, localized, base stations are well known in the art. Depending on the area of coverage and/or the number of simultaneous connections permitted, such base stations are known as fempto cells, pico cells, nano cells, micro cells, etc. A fempto cell may provide a coverage area as small as a 30 foot radius. In such a case, if a cell phone connects to the network through such a base station, it is known that the user is within 30 feet of the antenna. Multiple base stations may be placed around an area to provide a continuous coverage of the area and tracking of individual cell phones on a cell-by-cell basis.

### SUMMARY OF THE INVENTION

It is an object of the present invention to provide a human-wearable, carryable, or otherwise portable, system for providing accurate positional information over a defined coverage area, including building interiors. It is a further object of the present invention to provide a system for tracking such a sensor and providing asset tracking information. It still a further object of the present invention to provide tracking of shoppers in a retail environment and provide information to the shopper such as detailed directions to a desired good or service, items on sale near the shopper, coupon information for selected products, instructions in execution of an automated shopping list, measurement of time of decision making of the shopper in selecting goods, tracking of goods which were returned to the shelf before checkout to evaluate shopper decision making, and the like. Furthermore, the information gathered on a shopper's particular shopping experience could be aggregated for further tailoring of the next shopping experience. The data aggregation may either be tied to a particular device and individual, or it may be anonymous.

In one preferred embodiment the present invention will provide a system and method for tracking a plurality of user cell phones within a defined coverage area, including indoor areas of a building and/or within sub-surface structures. Such a system will include: at least one cell phone located within a predefined coverage area, or “campus”; a direction finding receiver, comprising a plurality of sensors, for receiving transmissions from the cell phone; a position server for calculating the position and tracking movement of the cell phone, and a database management server. In another preferred embodiment, the inventive system will further comprise at least one local cell through which the tracked cell phone communicates with a cellular phone network.

In still another preferred embodiment, the present invention will provide a local area location system and method for tracking people and things within a predefined coverage area, the system comprising: a plurality of badges worn by people to be tracked, each badge comprising an RF transponder; a host transceiver for requesting a pulse individually from each badge; a direction finding receiver for receiving pulses from the badges, the direction finding receiver comprising a plurality of sensors; and a position server for tracking individual badges. In a specific preferred embodiment, each badge will include a module for communication over an 802.11(b), (g), or (n) wireless network, the direction finding receiver configured to determine a source location for a packet transmitted on the wireless network.

In yet another preferred embodiment, the inventive system will be located within a retail shopping environment and used to target and possibly track shopper cell phones. In one embodiment, each of the targeted cell phones will be provided with an application which communicates with a shopper management processor such that the shopper may request step-by-step directions to products or services and the shopper can be made aware of nearby products which are on sale, offered spontaneous sale items, made special offers for products regularly purchased by the specific shopper, and the like. Further, in another preferred embodiment, shoppers may be able to request product reviews from other shoppers who are running the same application.

In another alternative embodiment, the targeted cell will be identified as being within the coverage area of a local base station with a limited coverage area. The local base station will provide the phone number and the dwell time in which the phone was proximate the local base station. If the dwell time is greater than a threshold, and if a user name and address can be discovered from the reported number, a sales lead is provided to the business where the base station is located.

In yet another preferred embodiment, the inventive tracking system will detect the presence and location of a non-registered cell phone within the coverage area, such as in a prison. The inventive system will determine that there is an unauthorized cell phone operating within the coverage area and give a precise location of the offending phone to prison officials on a computer based map.

In yet another preferred embodiment, the inventive system will track the presence and location of friendly users and detect non-registered cell phones within the coverage area, which coverage area might be a secure facility such as a prison. The inventive system will give an estimate of the location of the offending phone to the monitoring entity on a computer based map, and using inertial information from friendly users, could provide a 6 degree indication of their locations.

In yet another preferred embodiment of the inventive tracking system an additional antenna would be situated on the Z axis above (or below) the plane of the X/Y antennas in order to provide a vertical declination to the target cell phone. This would allow the inventive system to be used for seeing targets over multiple floors of a building. This embodiment could also provide a location solution with only two cells provided they were situated well above (or below) the floor that target cell phones would be moving across.

In yet another preferred embodiment of the inventive tracking system, a single direction finding femptocell site could be connected to a GPS and an inertial platform and flown on a helicopter or airplane over an area where a lost hiker, or like target, was suspected to be. The inventive direction finding system would find and log angular information to all received signals. A few moments later, after movement of the aircraft, the process would be repeated and by correlating angular information for each phone, the intersection of the pair of radials to each phone could be calculated to provide an exact location of the lost hiker.

In yet another preferred embodiment, the inventive tracking system will spontaneously send individualized text messages to the users of the cell phones detected within the campus coverage area. Such messages may be warnings of approaching dangers, information that another user on a friend list is nearby, suggestions of things to observe, etc. By way of example and not limitation, a cell phone carrying guest at a museum could be provided information about an exhibit as it is approached, could receive texts that provide background or interesting facts about the exhibit, much like cassette tours, except the system would allow a museum to be explored randomly instead of sequentially as required by prior art systems. It is contemplated that such texts could be sent/received within the local area coverage system and not within the user's wireless system. In this way, for those users who are charged for texts by their wireless carrier, such text charges will not be incurred by the present system.

In an embodiment, the invention will comprise a system for determining a location of a cell phone within a campus, comprising: an azimuthal detector at least for detecting a first time of arrival and an azimuthal direction of a cell phone signal originating from the cell phone, said first time of arrival being measured from a leading edge of said cell phone signal; at least one outrigger sensor positionable to be located remotely from said azimuthal detector, each of said at least one outrigger sensor at least providing an outrigger first time of arrival of said cell phone signal; and, a location server in communication with said azimuthal detector and with each of said at least one outrigger sensor, said location server at least for determining the location of the cell phone from said azimuthal direction, said first time of arrival, and any of said outrigger first time of arrivals.

In another embodiment, there will be a system for determining a location of a cell phone within a campus, comprising: at least three outrigger sensors positionable to be located remotely from each other, each of said at least three outrigger sensors at least providing an outrigger first time of arrival of a leading edge of a signal from the cell phone; and, a location server in communication with each of said at least one outrigger sensors, said location server at least for determining the location of the cell phone from at least three of said at least three outrigger first time of arrivals of the signal from the cell phone.

In still another embodiment, the instant invention teaches a method for locating cell phone within a campus, comprising the steps of: providing an azimuthal detector at least for detecting a first time of arrival and an azimuthal direction of a cell phone signal originating from the cell phone, said first time of arrival being measured from a leading edge of said cell phone signal; providing at least one outrigger sensor positionable to be located remotely from said azimuthal detector, each of said at least one outrigger sensor at least providing an outrigger first time of arrival of said cell phone signal; and, providing a location server in communication with said azimuthal detector and with each of said at least one outrigger sensor; and, within said location server determining the location of the cell phone from said azimuthal direction, said first time of arrival, and any of said outrigger first time of arrivals.

According to another embodiment, the instant invention teaches a method for locating cell phone within a campus, comprising the steps of: providing an azimuthal detector at least for detecting a first time of arrival and an azimuthal direction of a cell phone signal originating from the cell phone, said first time of arrival being measured from a leading edge of said cell phone signal; providing at least one outrigger sensor positionable to be located remotely from said azimuthal detector, each of said at least one outrigger sensor at least providing an outrigger first time of arrival of said cell phone signal; and, providing a location server in communication with said azimuthal detector and with each of said at least one outrigger sensor; and, within said location server determining the location of the cell phone from said azimuthal direction, said first time of arrival, and any of said outrigger first time of arrivals.

In another variation, the instant method will determine a location of a cell phone within a campus, by providing at least three outrigger sensors positionable to be located remotely from each other, each of said at least three outrigger sensors at least providing an outrigger first time of arrival of a leading edge of a signal from the cell phone; providing a location server in communication with each of said at least one outrigger sensors; within said location server determining the location of the cell phone from at least three of said at least three outrigger first time of arrivals of the signal from the cell phone.

In still another variation, the instant invention teaches a method of determining a location of a cell phone within a campus, wherein are provided a cell phone and a cell phone signal originating from the cell phone, comprising: sensing a first time of arrival of the cell phone signal and an azimuthal direction of said cell phone within an azimuthal detector, wherein said first time of arrival is determined from a leading edge of said cell phone signal; sensing said first time of arrival of the cell phone signal within a plurality of outrigger sensors, each of said plurality of outrigger sensors providing an outrigger first time of arrival at each of said plurality of outrigger sensors, wherein each of said outrigger first time of arrival is determined from the leading edge of said cell phone signal; transferring said azimuthal direction of said cell phone, said first time of arrival, and at least two of said outrigger first time of arrival to a location server; and, within said location server, determining an estimate of the location of a cell phone with the campus using at least said azimuthal direction of said cell phone, said first time of arrival, and at least two of said outrigger first time of arrival to a location server.

According to another embodiment, the instant invention will take the form of a system for determining a location of a cell phone within a campus, comprising: an azimuthal detector at least for detecting an azimuthal direction of a cell phone signal originating from the cell phone; at least two outrigger sensors positionable to be located remotely from said azimuthal detector, each of said at least one outrigger sensor at least providing an outrigger first time of arrival of said cell phone signal, wherein said first time of arrival is measured from a leading edge of said cell phone signal; and, a location server in communication with said azimuthal detector and with each of said at least two outrigger sensors, said location server at least for determining the location of the cell phone from said azimuthal direction, and at least two of said outrigger first time of arrivals.

Finally, in a further embodiment, the instant invention teaches a system for determining a location of a cell phone within a campus, comprising: a plurality of interferometers, each of said plurality of interferometers at least for detecting an azimuthal direction of a cell phone signal originating from the cell phone; a location server in communication with each of said plurality of interferometers, said location server at least for determining the location of the cell phone from said azimuthal directions from each of said plurality of interferometers.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 contains an illustration of the general environment of the invention.

FIG. 2 contains a schematic illustration of a sensor suitable for use with the instant invention.

FIG. 3 illustrates another sensor embodiment suitable for use with the instant invention.

FIG. 4 contains a schematic illustration of a location server suitable for use with the instant invention.

FIG. 5 shows the present invention employed in a system employing difference time of arrival.

FIG. 6 shows the present invention employed in a system including two loops and a whip.

FIG. 7 depicts one embodiment of the function generator 608.

### DETAILED DESCRIPTION OF THE PREFERRED EMBODIMENTS

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation. Before describing the preferred embodiments of the present invention, an explanation is provided of such terminology:

The term “direction finding” or “DF” refers to the art of finding the source location of, or a radial angle to, a radio frequency emitter.

The term interferometry refers to the study of relative phase angles between two or more signals of the same frequency.

The term “interferometer” refers to a sensor for measuring the relative phase angles from a plurality of antennas receiving a common signal. By using interferometry techniques to study the relative phase angles between pairs of antennas at known relative locations, an angle to the source of an RF emission can be obtained. Depending on the geometry of the array, the angle is either confined to a plane (an azimuthal sensor) or given in free space providing an azimuth and elevation.

The term “directional antenna” refers to an antenna having a known pattern. The directional response of the antenna may be augmented by providing a focusing element such as a parabolic reflector or an RF lens, or by adding passive elements such as in a Yagi antenna using reflectors and directors to focus the antenna. Additionally, directionality may be enhanced by adding active elements. One such technique is the use of a loop antenna summed with output of a whip antenna to produce a cardioid pattern with a sharp null on the backside of the pair.

The term “cell phone network” generically refers to the wireless network of a cell phone carrier, regardless of the technology or protocol employed by such carrier whether TDMA, CDMA, GSM, some combination thereof, or the like, or whether analog, digital, 3G, 4G, or the like, and without regard to scope of coverage whether regional, national, international, or the like.

The term “wireless Ethernet” is used to refer to a wireless network conforming to one or more of the 802.11(b), (g), (n), or other communication standards as such as adopted from time-to-time. Such systems are currently known to transmit in the 2.4 GHz band, 5.8 GHz band, or both.

The term “local cell” refers to a cellular base station located within, or proximate to, a predetermined locus, campus, or region in which tracking will occur. A local cell will typically be a microcell, nanocell, picocell, or femptocell, which are terms of art within the cellular phone industry and will be understood by one of ordinary skill in the art. By way of example and not limitation, a local cell may be a femptocell, picocell, nanocell, microcell, or a software radio connected to a host executing OpenBTS or other base station software.

The term “location server” refers to a processor which receives time of arrival information and/or angular information from a plurality of sensors and calculates a source location for an emitter based on the received information. Additionally, in some embodiments the location server might include additional hardware such as a femptocell, picocell, nanocell, microcell, or a software radio connected to a host executing OpenBTS or other base station software. Thus, when the term ‘location server” is used herein that term should be understood to mean at least a processor capable of executing a computer program that is designed to locate an RF emitter by using a plurality of arrival times. It may further include a cell base station integrated with, or in communication with, the location server.

The term “software defined radio” or “SDR” refers to a radio receiver, transmitter, or transceiver wherein tuning, modulation and/or demodulation are performed by software running within a processor. As is well known in the art, such processors can demodulate the carrier directly on relatively low frequency radios or demodulate an intermediate frequency in a heterodyne receiver wherein the intermediate frequency is produced by mixing the received RF signal with the output of a local oscillator.

The terms “processor”, “microprocessor”, CPU, etc., as used herein should all be broadly construed to include any active/programmable device to include, without limitation, single and multi-chip microprocessors, micro controllers, gate arrays, programmable logic devices (“PLDs”), FPGAs or ASIC, etc.

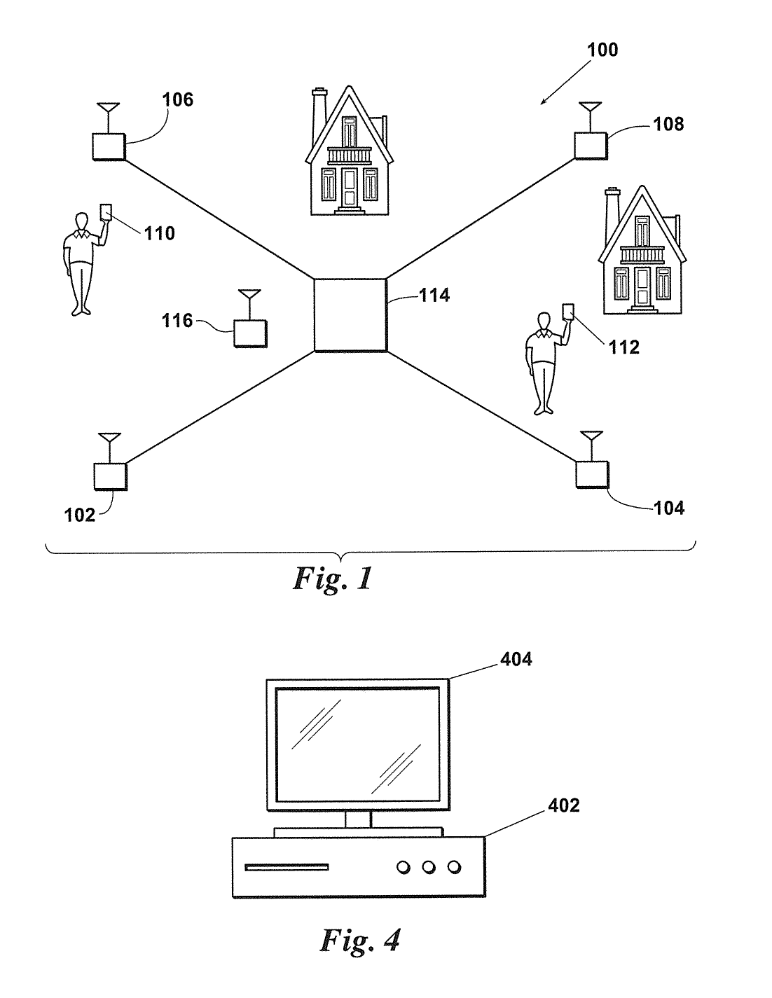

Referring now to the drawings, wherein like reference numerals indicate the same parts throughout the several views, a system 100 for tracking people and/or items locally within a predefined campus is shown in its general environment in FIG. 1. Note that for purposes of the instant invention, the term “campus” will be used to refer to an indoor and/or outdoor region of relatively limited extent. In the instance where there are wired (or WiFi) connections between the sensors 102-108 and the location server 114, the preferred campus size will typically be one square mile or less. Where the instant invention is installed within a single structure, it is anticipated that in most cases the campus size will be smaller than, say, about 400 feet on a side (or 16,000 square feet). That being said, since a cell phone 110/112 transmission might be detected as far away as 20 miles, it should be clear that it will be possible to cover a wide variety of campus sizes. Further, in the case that the campus covers an outside region that contains structures thereon, it might be beneficial to have an indoor system installed in one or more of those structures.

Typically, a network of inventive sensors 102-108 will be located in a known positional relationship within, or proximate to, the campus. In some embodiments, the sensors might be 25 to 400 feet apart and positioned proximate to the extremity of the campus. Of course, they might be placed closer together or further apart depending on the particular configuration and size of a given campus. For purposes of the instant invention, a collection of spaced apart sensors suitable for use with the instant invention will be referred to as a collection of “outrigger” sensors. It would be anticipated that that the outrigger sensors would provide at least a time-of-arrival of a cell phone signal and might additionally provide azimuthal/directional information. Knowledge of the size of the campus, the structures present thereon, and numerous other factors will likely be considered in determining the number, placement, and type of sensors necessary to locate a cell phone to a particular degree of accuracy. Further, given the type of sensors and their placement, those of ordinary skill in the art will be readily able to device a computer program to deduce the location of a particular cell phone within the campus given input of the sort taught herein.

The sensors 102-108 will periodically intercept at least RF signals from cell phones 110 and 112 and forward the inferred directional information to location server 114. Of course, those of ordinary skill in the art will recognize that a cell phone is just one example of an RF transmitter that could be located using the techniques described herein.

The sensors 102-108 will be in electronic communication with the location server 114 either via a wired or wireless connection to allow transfer of data and/or commands back and forth between server and sensors. Server 114 will receive the directional information from sensors 102-108, determine a source location for the cell phone 110 or 112, associate the position with the appropriate cell phone 110 or 112, archive the positional information, and make the information available to authorized users or for management programs. Optionally, one or more local cell base stations 116 may be located within, or proximate to, the campus. Local cell base station 116 will serve a number of purposes, as will be discussed in more detail hereinafter, however at the very least station 116 will ensure that cell phones operating in the campus will have predictable signal strengths and continuous service.

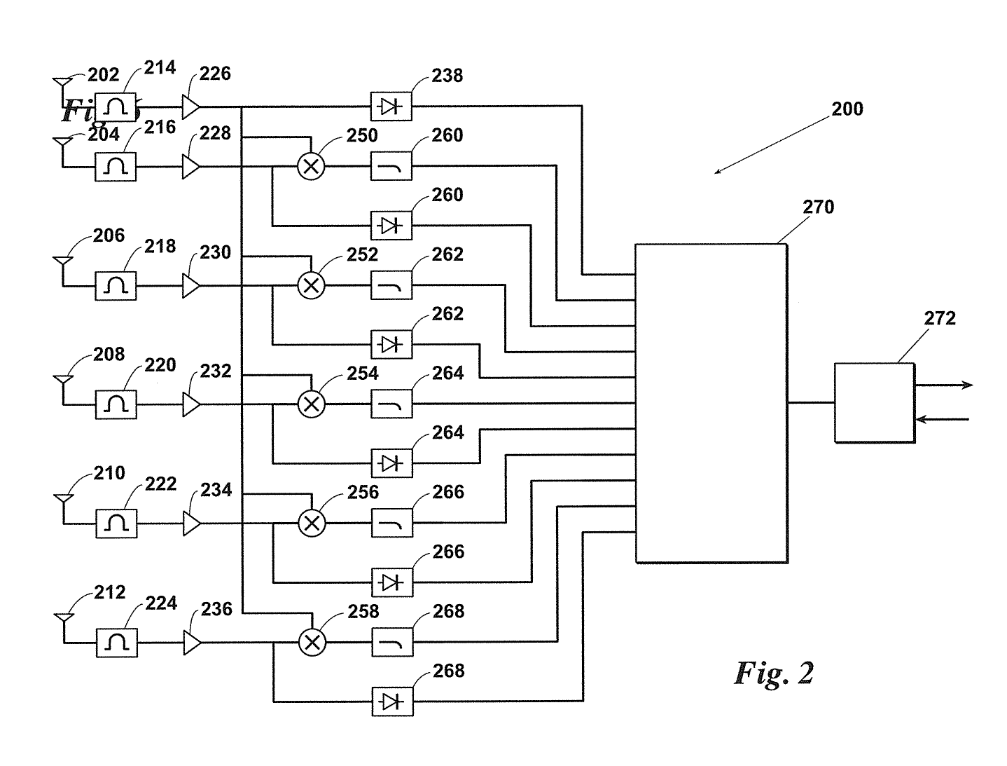

With reference to FIG. 2, in one preferred embodiment a sensor 102 will comprise an interferometer. A key problem in interferometry is maintaining a consistent phase relationship between the signals from the various antennae of the sensor. This becomes particularly troublesome when heterodyne techniques are employed, e.g., to make a tunable receiver and to improve rejection of out-of-band signals. One embodiment will employ a single channel radio and rapidly switch each antenna to individually provide the input to the receiver. Another embodiment will use a multi-channel receiver and either a common local oscillator, or alternatively, precisely phase locked local oscillators. One of ordinary skill in the art would recognize that phase angle comparison is traditionally performed using hybrid couplers, a specific example is, without limitation, a magic tee. Finally, a third embodiment will compare the phase angles by working with the carrier frequency directly. The present invention will not be limited to a particular method of deducing a relative phase angle from the received signals. Techniques for deriving relative phase angles are well known in the art, whether such measurements are made in the time domain or frequency domain. The previous text should be understood to merely indicate that relative phase angles can be measured.

By way of example and as is generally indicated in FIG. 2, preferably sensor 102 will comprise: a plurality of antennas 202-212, each antenna being located at a known position relative to every other antenna; a plurality of narrow-band filters 214-224, with one filter being in communication with the output of each antenna; a plurality of RF amplifiers 226-236 with one amplifier being associated with each filter for receiving the output of the filter and boosting the signal; a plurality of detectors 238-248 at least for detecting the amplitude of the signal received at each antenna; a plurality of mixers 248-256 for multiplying the output of each antenna 204-212 with the output of the reference antenna 202; a plurality of low-pass filters 258-266 in communication with the output of each mixer, the output of each filter being representative of the phase angle difference between the signal received at the reference antenna and the signal received at the appropriate companion antenna; and a processor 268 for converting the output of each low-pass filter to a digital value, converting the output of each detector to a digital value, computing a table of relative phase angles, and determining an angle of arrival for the received signal. Sensor 102 further will preferably include a network interface 270 for forwarding directional information to location server 114 (FIG. 1). In some embodiments, the antennas 202-212 will be spiral, whip, dipole, or other conventional antennas.

In one embodiment, a first companion antenna 204 will be located ½ wavelength from reference antenna 202, a second companion antenna 206 will be located 3/2 wavelengths from reference antenna 202, a third companion antenna 208 will be located 7/2 wavelengths from reference antenna 202, a fourth companion antenna 210 will be located 15/2 wavelengths from reference antenna 202 and a fifth companion antenna 212 will be located 31/2 wavelengths from reference antenna 202, the particular wavelengths being based on the lowest frequency expected to be received. It should be noted that this is a recognized geometry for interferometry but is not a necessary or essential one. In fact, the relative placement of the various antennae would not be subject to such placement for a wide-band interferometer. Further, other geometries may be better suited to reducing ambiguities in the angular information and, in particular, arrays arranged in a nonlinear fashion potentially will provide better accuracy since a source cannot be perpendicular to the entire array. Those of ordinary skill in the art will be able to devise an array geometry that would be suitable for use in a particular case.

In a typical embodiment, sensors 104-108 will be of similar construction to that discussed with regard to sensor 102. However, as will be discussed in more detail hereafter, a system may combine interferometer sensors with other types of sensors to create a hybrid direction finding system.

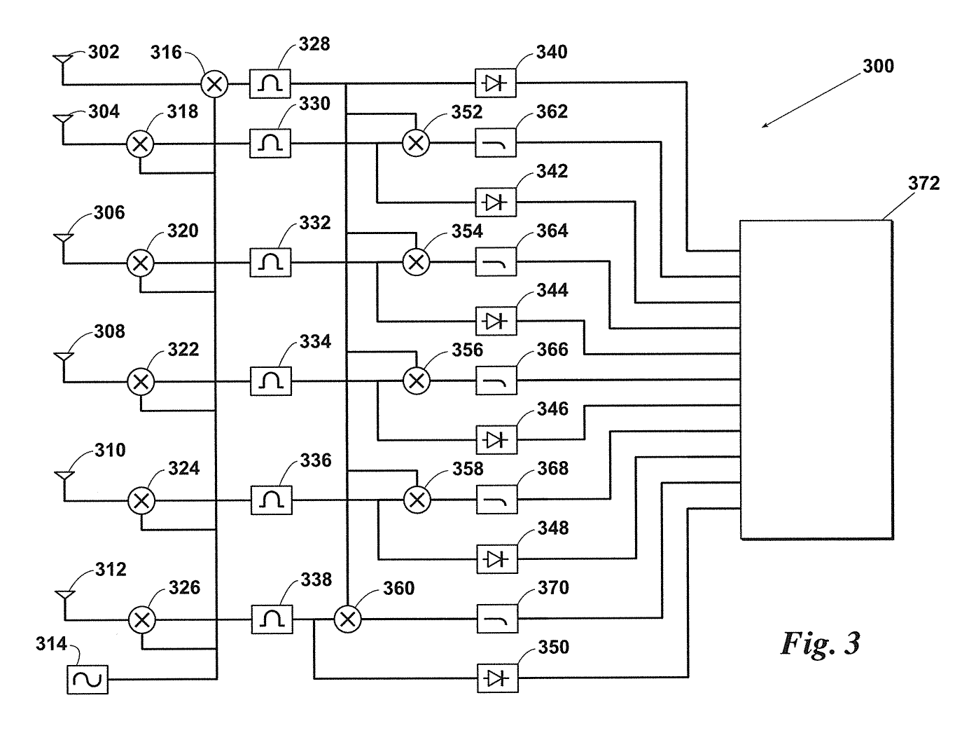

As will be apparent to one of ordinary skill in the art, the sensor of FIG. 2 will only receive a single cell phone channel, or simultaneously receive several cell phone channels, depending on the bandwidth of the narrow band filters, and neither situation is ideal. Thus, and turning to FIG. 3, a more practical sensor would be of similar design except each channel could comprise a heterodyne receiver. While such receivers are well known in the art, a brief description is provided, by way of example and not limitation. Sensor 300 comprises: a plurality of antenna 302-312; a tunable local oscillator 314; a plurality of mixers 316-326 which multiply the output of each antenna by the local oscillator output to produce an output at an intermediate frequency (IF), preferably either 70 MHz, 45 MHz, or 10.7 MHz; a plurality of narrow band filters 328-338 which only pass signals at the appropriate intermediate frequency; a plurality of detectors 340-350 for detecting the amplitude of each received signal; a plurality of mixers 352-360 for multiplying the reference signal with each companion signal; a plurality of low-pass filters 362-370 for separating the phase angle information from high frequency images from each mixer; and a processor 372 for digitizing and processing the signals as discussed with regard to the embodiment of FIG. 2. It should be noted that care should be given to using the same local oscillator for each channel or providing precisely phased locked local oscillators for each channel so that the relative phase angles between the received signals can be measured. As will be apparent to one skilled in the art, frequency variation between the local oscillators will result in the various intermediate frequencies will differ. Phase angle is only defined between signals of like frequency or precise harmonics. While interferometer sensors are subject to providing erroneous results in highly reflective environments, the effects of multipath can be reduced by taking the measurement on the rising edge of the received signal, at least in pulsed systems.

As will be apparent to one of ordinary skill in the art, sensors 102-108 could alternatively employ other methods for determining angle of arrival. By way of example and not limitation such methods include implementation of the Watson-Watt technique for using two Adcock antenna pairs to determine angle of arrival, a circular array employing Doppler shift techniques, or an array of directional antennae such as two loops and a whip.

By way of example, with reference to FIG. 6, an alternative sensor 102 comprises: two loop antennas 602 and 604; a whip antenna 606; a waveform generator 608 operating at a predetermined frequency having a sine wave output 610 and a cosine wave output 612; a first mixer 618 for multiplying the output 603 of loop 602 with output 610; a second mixer 620 for multiplying the output 605 of loop 604 with output 612; a summing amplifier 622 for combining the outputs 614 and 616 of mixers 618 and 620, respectively and the output 607 of whip 606; and a detector 624 for determining the amplitude of the received signal.

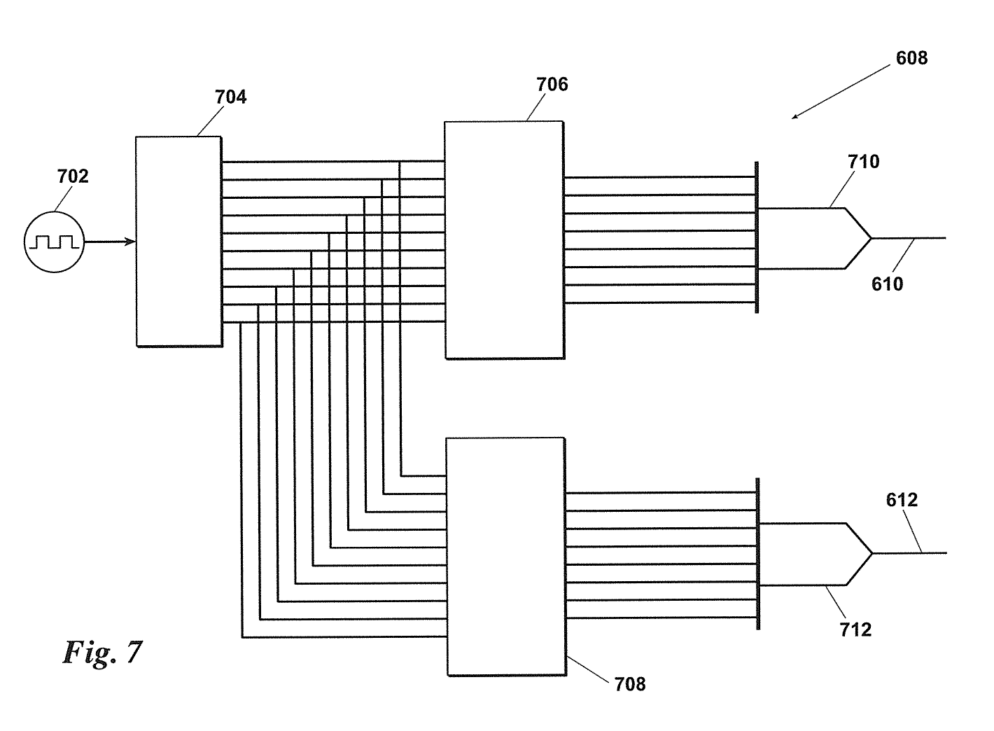

With further reference to FIG. 7, preferably waveform generator 608 comprises an oscillator 702; a counter 704; a sine memory 706; a cosine memory 708; a sine digital to analog converter 710 which provides sine wave output 610; and a cosine digital to analog converter 712 which provides cosine output 612. The waveforms of memories 710 and 712 preferably contain identical sine waves, one is just stored with a 90 degree offset relative to the other. Thus, counter 704 advances on each cycle of oscillator 702. The count is then used to address a value stored in the addressed memory location which is, in turn, converted into an analog value. While the function generator 608 has been described as being embodied in hardware for the sake of clarity, it will be apparent to one of ordinary skill in the art that the functions could be easily, and probably more economically, be embodied in a common microprocessor or microcontroller, in combination with a common audio codec. In a software defined embodiment, typically an interrupt would be set to occur at regular intervals. In the interrupt routine, a counter would increment, a value would be looked up from a sine wave table, a value would be looked up with a 90 degree offset from the same table, and the values would be forwarded to two channels of an audio codec.

Typically, in this embodiment the two loops 602 and 604 will be placed at 90 degrees to each other and vertical whip 606 will be placed proximate the loops. Loop antenna 602 has a figure-eight pattern of reception. When combined with a whip 606, on the forward side of the loop, the RF signals will be additive and the signal strength will be doubled. On the backside of the loop, the signals will be subtractive, and a sharp null will be produced where the signals are equal, perfectly centered in the backside of the pattern if the antenna gains are equal. This null is easily detected. By mixing the outputs of the two loops with the sine and cosine outputs of oscillator 608, the null may be electronically rotated to produce a rotating cardioid pattern. When the null is detected, the value of counter 704 provides a numeric indication of the angle to the source.

Mathematically, since 100% modulation is simply multiplication if:
the output 603 of the first loop 602 is given by x;
the output 605 of the second loop 604 is given by y;
the output 607 of the first whip 606 is given by v; and

then the output z is:

z=v+(x*SIN(ωt)+y*COS(ωt)), hence the single whip solution.

This embodiment uses this scheme with a whip 606 and loops 602 and 604, all set at orthogonal angles to each other. This scheme then provides an azimuth and a Received Signal Strength (RSS) for a given azimuth. A problem is that a low powered cell phone device placed closely to the sensor would look just like a high powered cell phone device which is a hundred yards away. The inventive device will solve this problem using another node (as shown in FIG. 1) looking at the same target, their azimuths can be compared and the intersection of the two vectors will provide an estimate of the location of the target.

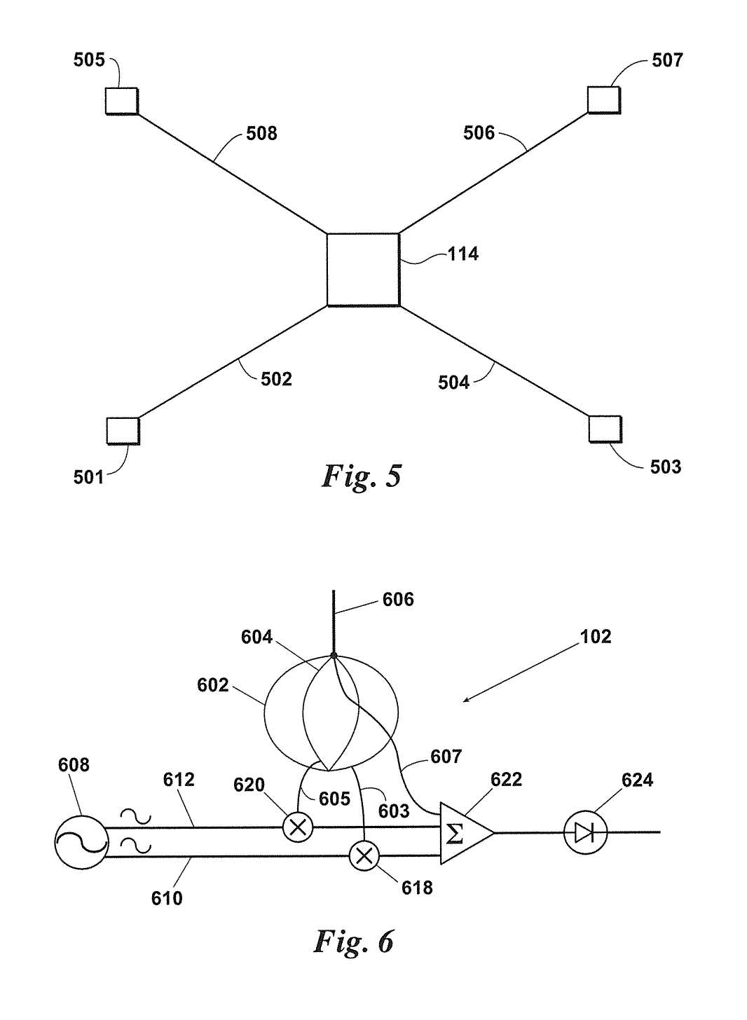

Turning next to FIG. 5, in another preferred embodiment, sensors 501-507 could measure absolute time of arrival, instead of angle of arrival. If sensors 501-507 are at known locations, location server 114 can calculate a position of the source of the signal using differential arrival times. In such a system, the demodulated signals from the sensors could be routed by wires 502, 504, 506, and 508 to location server 114. In some embodiments the time difference will be calculated from a common clock. In other embodiments, at server 114 a cross correlation could be performed on the demodulated signals to derive a difference time of arrival on either pulsed or CW signals. It should be noted that this scheme is less affected by multipath signals in a highly reflective environment than the other techniques discussed hereinabove, particularly when measurements are made immediately on receipt of a rising edge of a pulsed. Of course, it is well known in the art how to determine a location based on a collection of a differential arrival times. The same signal will be received at slightly different times at sensors 501-507. In some embodiments, the sensors 501-507 will be some combination of azimuthal and arrival time sensors. In other embodiments, some of the sensors 501-507 will be arrival time sensors that also are capable of determining the azimuth of the cell phone signal.

In some embodiments the sensors of the instant invention will determine arrival times based on sensing the leading edge of the RF cell phone signal. For purposes of the instant disclosure, the term “leading edge” will be defined to be the start of a cell phone transmission. In the case of a TDMA transmission scheme, the leading edge would be typically the start of a packet since TDMA transmits in packets and packets are sent several times a second with gaps in between. In the case of CDMA, that might mean pinging the phone (if the person was not talking at that moment) or sending a request to the phone that asks it to change to a different band or channel, in which case the start of transmission in the new band/channel would have a clear leading edge. This might be accomplished, for example, through the use of something like a femptocell or tower simulator that would periodically direct the phone to change frequencies so that a leading edge of the transmission on the new frequency could be detected. Of course, those of ordinary skill in the art will recognize that the GSM protocol is a variation of TDMA.

It will be understood by one of skill in the art that all data/information/signals transmitted between the sensors and the location server could be encrypted so as to protect the security of the information, user, or the system itself. Encryption of the data/information/signals may be accomplished in a known manner as would be understood in the art.

With reference to FIG. 4, a typical location server 114 comprises a desktop computer such as those commonly referred to as PCs or Macs. While such computers are well known in the art and no discussion of the particulars is necessary, by way of example and not limitation, the computer 400 embodiment of FIG. 4 includes: a CPU 402 internally having a power supply, mass storage, random access memory, a processor, a video interface, a network interface, as well as other peripheral devices commonly found in such computers; and a monitor 404 for communication with a user. Preferably software that uses the data provided by the sensors 102-108 to locate and/or track cell phones within the campus will be stored on a local or remote disk and made accessible to the computer 402 that executes it. The functions performed by the software in some embodiments will preferably include a routine for receiving directional information from sensors 102-108 (FIG. 1) and computing a source location at the intersection of the lines defined by the angular information received from the sensors. The software will then determine the nearest phone from the previous measurements and update the phone position. The software will then show the new position on monitor 404, archive the information on a mass or other storage device, forward the information to any other computer authorized to receive the device, determine if any messaging is required and, if so, perform the required messaging.

As will be apparent to one of ordinary skill in the art, each sensor need not decode or process any information from the phone to determine angular information or time of arrival information. Further, the location server does not depend on having any particular information about the identification of the phone to track its movements. However, if one or more sensors, or an independent receiver receives identification information from the cell phone, that information could be stored along with the tracking information in server 114.

It should be noted that many newer cell phones include some components of an inertial navigational platform such as accelerometers, gyros, magnetometers, and the like. In a preferred embodiment, a cell phone contacts the location server upon entering the campus and, in response to a direction from the server, the phone will attempt to continuously calculate its own position. Periodically the local area location system will provide accurate positional information back to the phone to correct drift and inaccuracies in the phone's positional calculations, otherwise known as augmentation. In turn, the phone will periodically report its position to the location server so that the server can easily resolve ambiguities that might occur when, for example, two phones pass close together.

As will be understood by one of ordinary skill in the art, the system of the present disclosure may be configured for many useful applications. The following are examples of such applications and should be considered as such and not as limitations. It is understood that many other additional applications are contemplated. In one such application and as a first example, geolocation will be determined by two or more interferometer based cell sites which are separately located with known positions. Each cell will independently determine a vector to the cell phone, the vectors will then be compared and their crossing point will determine the location of the cell phone. This system could provide a location solution using only 2 cell sites.

In another preferred embodiment the geolocation will be determined by using the time differences between arrivals from 3 or more separately located cell sites. The cell site locations will be surveyed and the time it takes for the cell phone's signal to travel to each will be measured and compared. The time differentials will then be used to determine the location of the cell phone. This system would require at least 3 cell sites to give an absolute position. In another embodiment, an azimuth detector that also provides a time of arrival will be used in combination with a spaced apart arrival time sensor.

In one preferred embodiment the geolocation is determined by one or more interferometer-based cell sites which are separately located and their positions known and they each independently determine the vector to the cell phone and by using difference time of arrival they can determine how far away the cell is which determines the cell phone's precise location. This system requires only one cell site to determine the precise location of a cell phone. If t₀, is known, or can be calculated, it is possible to employ a single interferometer.

In one application, that of a retail environment, the inventive system listens for unique data that a plurality of cell phones transmit to a cell phone tower. Once it has been detected, the device will then be geo-located within a campus such as a store or parking lot. The server software then checks to see if the specific phone is registered within its database for an enhanced shopping experience. The phone could either be registered through an OPT-IN remote process (such as a Website, Rewards Card application, etc.) or the user of the cell phone may register using the cell phone at the store, in either case at the time of registration a phone-side (client-side) application will preferably be transmitted to, and installed on, the user's phone. If the user chooses not to accept the OPT-In request, then some functionality will preferably be disabled. In the case of a registered phone, if the application is not running on the cell phone, then it will be automatically loaded. If the user has disabled automatic loading of the software, an alert will be sounded notifying the user that the enhanced shopping experience will not be activated.

In the case of a cell phone that has activated the software, in a preferred embodiment a personalized customer profile will be loaded that includes the customer's shopping list, rewards card number and associated electronic coupons, current sales/promotions at this particular store, etc. The server-side software, which will be able to utilize the geolocation of all products that are offered for sale within the store, will calculate the optimum shopping path to obtain all the items on the shopping list and prompts the user to follow its directions. The user may choose to ignore or follow the directions. However, when the user's location is proximate to any item on the shopping list, in this embodiment a state change will occur that will mark that item as possibly in the shopping basket and further directional guidance will be suspended for that item. Similar or complementary items that are on sale proximate to the target item may be displayed to the user on the cell phone screen. Then the next item on the shopping list will take control and the process repeats itself.

Preferably, at any time during the visit to the store, the user will be able to activate a “Find Associate” functionality. The user may search by Department, Special Skill set, or the Closest Associate. Once a selection of an associate has been made, the server based component will notify the associate and provide the user with directional guidance that will preferably be updated in real-time, to reflect the associate's current location. The software also may provide a queuing mechanism to the associate in case more than one user is attempting to find a particular associate. If there a queue has formed, the user will be notified.

Furthermore, in another preferred embodiment anytime during the store visit the user may search for a specific product. If the product is offered for sale within this facility and is in-stock, it will be added to the shopping list and directional guidance will be given. As before, the server software, which maintains the geolocation of all products for sale within the store, will calculate the optimum shopping path to obtain all the items on the shopping list and will prompt the user to follow its directions. The user may choose to ignore or follow the directions. However, when the user arrives at any item on the shopping list, a state change will occur marking that item as possibly in the shopping basket and further directional guidance will be suspended for that item. Similar or complementary items that may be on sale could be displayed to the user. If an item sought by a user is not offered for sale or is out-of-stock, the user will be notified. Alternatives to that specific product, if available, will preferably be suggested.

As one of ordinary skill in the art of geo-marketing will know, the shopping behavior of the customer is a key variable in product selection, placement, flow thru the store, etc. The date and time of the shopping session is a preferred reference point for a single visit. Additional data, as known to those who practice the art, such as time spent browsing selections, time spent in specific product areas, amount of revisits to a specific product and the like are all important to the customer's shopping behavior. This sort of data is stored, in the case of a registered user, in great detail and in the case of a non-registered user without the identifying data of the actual user.

Once the user has finished shopping and is at the checkout location, rewards information may be electronically transferred to the cash register. This transfer could be initiated by, for example, holding the phone over a scanner to show a picture of the user's rewards card. In other embodiments, a machine to machine transfer from the user's phone to the store's computer system might be utilized.

Once the user has completed check out, and in accordance with local law, they may be allowed to pay for their items using their cell phone. If use of such a form of payment is not possible, then an alternative method of payment will be used. In either case, the server software will preferably communicate with the Point of Sale (POS) system and cross reference the items purchased with the shopping list. If there are items missing from the items purchased an alert to the user will preferably be issued.

The system of the present disclosure may also provide for the user to receive shopping list updates while within the store. By way of example, while a husband is at the store shopping for items, his wife might determine that another item is required. She could then electronically transmit the item needed to him. The item could then automatically be added to the shopping list, thereby forming an augmented shopping list. Preferably, the husband will be notified via an alert of some sort that this has happened. The preferred embodiment of the invention would then operate substantially as describe above with respect to augmented shopping list.

Once the shopping experience has been completed, this instance of the shopping experience will preferably be added to either the registered user's history or to a generic history. The shopping history can then subsequently be mined for specific data to either further personalize the next shopping experience or to provide marketing insight.

In another application of the present disclosure, the inventive system may search and locate unauthorized use of cell phones within the campus. By way of example and not limitation, the use of cell phones by inmates of campuses consisting of prisons or jails is of concern. In this application, the inventive system will listen for the unique identifying cell phone information and cross check this information against an authorized user database. If the cell phone is authorized for use, interruption or denial of service will not occur. If the cell phone is not authorized for use within the campus, in a preferred arrangement it will be immediately geo-located, an alert will be issued, and service will be be denied. In this manner, the system of the present disclosure may include denial of cell phone service in a non jamming manner. In addition, if local law and regulations allow, the voice data, SMS, and/or web traffic associated with that phone may be intercepted and stored for future use. If the offending cell phone is powered down, its last known location will be maintained in help order to locate that device. The location of prison employees may also be calculated and maintained in a real time manner using the instant invention. If desired, the location of an unauthorized cell phone may be transmitted to prison employees to facilitate their location and confiscation of the unauthorized cell phone.

In another application of the system of the present disclosure, the inventive system may search for cellular devices present within a secure campus area. In this application, a database will be maintained of authorized (users of) cellular devices and identifying information related to the authorized cell phone (e.g., the phone number, serial number of the phone, etc.). In this embodiment, the location of all cell phones on the campus will be continuously maintained, updated, and displayed, either on a computer terminal or on a plurality of authorized devices. Additional layers of encryption may be utilized to provide an increased level of security. A receive-only base station could be used to obtain the serial number from any phone on the campus. However, it would generally be preferred to have a two-way base station to make it possible to ping the cell phone for purposes of obtaining its serial number. Additionally, given the serial number if it were desired to obtain the phone number of the associated phone, commercial services are available to provide such information.

By way of example and not limitation, the use of the inventive system within an secure location would provide for real time location of visitors, security forces, prison guards, etc. This information could be displayed on a central console and made available to selected individuals of the staff. In some case an alarm will be generated when an unauthorized (previously unregistered) phone is brought onto the campus. The alarm might consist of a printed message, an audible alarm, an automated phone call, etc. In some embodiments, the monitoring individual(s) will use the location information to know where to find the unauthorized cell phone on the campus.

The inventive system could also monitor for unauthorized cellular devices and, if located outside of a “safe area,” an alert could be given and directional guidance given through a geo rectified map, written or spoken directions, etc. Such would make it possible to identify and locate cellular devices that had been smuggled into, for example, a prison or other secure facility.

According to another aspect of the present disclosure, the inventive system will be installed along a portion of a road. In this aspect, the system will listen for all cellular devices moving thereon and calculate vehicle speed, direction of travel, and if there are multiple cell phones in a vehicle, counts them as one. This allows the inventive system to calculate traffic density, estimated travel time, calculate travel delays, etc. Furthermore, if installed at a weigh-station, and the truck had previously registered with the system, all required transportation documentation could be transferred electronically to the operators of the weigh-station in advance of the arrival of the truck. An additional embodiment is if the inventive system could be installed at a toll-booth and, if the user has previously registered and has the appropriate amount of credit, the toll might be paid via cell phone.

In another application, the system of the present disclosure may be installed within a conference complex and employed for trade shows and the like. The system will then listen for cellular devices(s) registered to conference attendees. By way of explanation, but not of limitation, the cellular device will be located within the conference campus. If the cellular device is on the outside of the conference “secure” area, the user may be directed to an automated entrance. This entrance would again locate the cellular device and allow the registered conference attendee reenter the conference area. Once inside of the conference area, the user will preferably employ the instant system to navigate to those booths that are of interest, could find another conference attendee; keep track of those booths already visited, etc. The user's data could be archived and available for data mining purposes.

In yet another application, the system of the present disclosure may be installed at large theme park campuses. A wrist band could be applied to a child, a picture taken of the child and added to the system for further identification of the child. The wrist band could be keyed or otherwise attached to the parents/adults cell phone. In the event the child becomes separated from his/her parents, the system would notify the adults, security, and/or park workers in order to help locate the child.

In yet another application, the system of the present disclosure may be installed within a campus warehouse or the like, and this application would be especially useful where the warehouse stored high value products. In this arrangement, each high-value item stored therein would have a wireless or cellular device (tag) attached to it. This device would preferably be equipped with a power management scheme that would include a sleep timer, magnetometer, and/or an accelerometer. The system of the present disclosure would then be able to locate the high value product and periodically poll for a response. If the high value item is moved, the “tag” would wake up from its low power state and send an alert to an operator for action.

In yet another application, the system of the present disclosure may be installed within a retail store. All employees of the store may be equipped with a “badge” that contains either a wireless or cellular device. This badge would then enable real-time location of all employees. This information could then be used as a time keeping mechanism (e.g., for determination of hours worked), as a loss mitigation system, and as a method of opening secure locations, among others.

In still another application, the system of the present disclosure may be adapted so as to provide local area emergency or “911” service. In this application, a user within a campus such as a shopping mall or sports arena, and particularly the associated parking areas which are monitored by video cameras, could dial an emergency number such as “911” or an equivalent. Once dialed, the local area system would locate the caller and automatically direct all or a portion of the cameras toward the caller in distress so as to monitor the caller until emergency personnel arrive. In the alternative, once the caller has been located, the cameras could be manually directed toward the caller. The video surveillance could be accompanied by audio or other assistance provided. While not intercepting or monitoring the 911 call, local security personnel could nonetheless be dispatched to the location of the cell phone and would likely arrive before emergency responders.

In previously mentioned preferred embodiments, the term “cell phone” was used but because the inventive local cell stations which are ideally based on FPGAs or ASICs can be programmed to search for almost any continuous or non-continuous RF transmission over a wide range of frequencies. It is understood that the “cell phone” could be substituted with a Wi-Fi device, RFID card, or other wireless transmitter. In embodiments where the RF device is Wi-Fi enabled, the instant invention will preferably utilize the arrival time (leading edge) of a transmitted package. In some cases, the subject device will be pinged to initiate a transmission that falls within a given time window. If the wireless device has a MAC address or digital serial number, the instant system could be used to identify the location of individual tagged items or individuals carrying the wireless devices.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A system for determining a location of a cell phone within a campus, comprising:
a. an azimuthal detector at least for detecting a first time of arrival and an azimuthal direction of a cell phone signal originating from the cell phone, said first time of arrival being measured from a leading edge of said cell phone signal;
b. at least one outrigger sensor positionable to be located remotely from said azimuthal detector, each of said at least one outrigger sensor at least providing an outrigger first time of arrival of said cell phone signal; and,
c. a location server in communication with said azimuthal detector and with each of said at least one outrigger sensor, said location server at least for determining the location of the cell phone from said azimuthal direction, said first time of arrival, and any of said outrigger first time of arrivals.

2. The system for determining the location of a cell phone within a campus according to claim 1, wherein said azimuthal detector is an interferometer.

3. The system for determining the location of a cell phone within a campus according to claim 1, wherein at least one of said outrigger sensors is an outrigger azimuthal detector.

4. A system for determining a location of a cell phone within a campus, comprising:
a. at least three outrigger sensors positionable to be located remotely from each other, each of said at least three outrigger sensors at least providing an outrigger first time of arrival of a leading edge of a signal from the cell phone; and,
b. a location server in communication with each of said at least one outrigger sensors, said location server at least for determining the location of the cell phone from at least three of said at least three outrigger first time of arrivals of the signal from the cell phone.

5. The system for determining the location of a cell phone within a campus according to claim 4, wherein said at least three outrigger sensors are at least four outrigger sensors.

6. A method for locating cell phone within a campus, comprising the steps of:
a. providing an azimuthal detector at least for detecting a first time of arrival and an azimuthal direction of a cell phone signal originating from the cell phone, said first time of arrival being measured from a leading edge of said cell phone signal;
b. providing at least one outrigger sensor positionable to be located remotely from said azimuthal detector, each of said at least one outrigger sensor at least providing an outrigger first time of arrival of said cell phone signal; and,
c. providing a location server in communication with said azimuthal detector and with each of said at least one outrigger sensor; and,
d. within said location server determining the location of the cell phone from said azimuthal direction, said first time of arrival, and any of said outrigger first time of arrivals.

7. A method for locating cell phone within a campus, comprising the steps of:
a. providing an azimuthal detector at least for detecting a first time of arrival and an azimuthal direction of a cell phone signal originating from the cell phone, said first time of arrival being measured from a leading edge of said cell phone signal;
b. providing at least one outrigger sensor positionable to be located remotely from said azimuthal detector, each of said at least one outrigger sensor at least providing an outrigger first time of arrival of said cell phone signal; and,
c. providing a location server in communication with said azimuthal detector and with each of said at least one outrigger sensor; and,
d. within said location server determining the location of the cell phone from said azimuthal direction, said first time of arrival, and any of said outrigger first time of arrivals.

8. A method for determining a location of a cell phone within a campus, comprising:
a. providing at least three outrigger sensors positionable to be located remotely from each other, each of said at least three outrigger sensors at least providing an outrigger first time of arrival of a leading edge of a signal from the cell phone;
b. providing a location server in communication with each of said at least one outrigger sensors;
c. within said location server determining the location of the cell phone from at least three of said at least three outrigger first time of arrivals of the signal from the cell phone.

9. A method of determining a location of a cell phone within a campus, wherein are provided a cell phone and a cell phone signal originating from the cell phone, comprising:
a. sensing a first time of arrival of the cell phone signal and an azimuthal direction of said cell phone within an azimuthal detector, wherein said first time of arrival is determined from a leading edge of said cell phone signal;
b. sensing said first time of arrival of the cell phone signal within a plurality of outrigger sensors, each of said plurality of outrigger sensors providing an outrigger first time of arrival at each of said plurality of outrigger sensors, wherein each of said outrigger first time of arrival is determined from the leading edge of said cell phone signal;
c. transferring said azimuthal direction of said cell phone, said first time of arrival, and at least two of said outrigger first time of arrival to a location server; and,
d. within said location server, determining an estimate of the location of a cell phone with the campus using at least said azimuthal direction of said cell phone, said first time of arrival, and at least two of said outrigger first time of arrival to a location server.

10. A method of determining a location of a cell phone within a campus, wherein are provided a cell phone and a cell phone signal originating from the cell phone, wherein is provided a phone database at least containing a plurality of authorized cell phone I.D.s, comprising the further steps of:
e. obtaining identifying information from the cell phone;
f. accessing the phone database;
g. comparing said identifying information from the cell phone with at least a portion of said authorized cell phone I.D.s to determine whether the cell phone is authorized;
h. if the cell phone is not authorized, generating an alarm; and,
i. if the cell phone is authorized, continuing to determine the location of the cell phone.

11. A system for determining a location of a cell phone within a campus, comprising:
a. an azimuthal detector at least for detecting an azimuthal direction of a cell phone signal originating from the cell phone;
b. at least two outrigger sensors positionable to be located remotely from said azimuthal detector, each of said at least one outrigger sensor at least providing an outrigger first time of arrival of said cell phone signal, wherein said first time of arrival is measured from a leading edge of said cell phone signal; and,
c. a location server in communication with said azimuthal detector and with each of said at least two outrigger sensors, said location server at least for determining the location of the cell phone from said azimuthal direction, and at least two of said outrigger first time of arrivals.

12. A system for determining a location of a cell phone within a campus according to claim 11, wherein at least one of said at least two outrigger sensors is located proximate to said azimuthal detector.

13. A system for determining a location of a cell phone within a campus according to claim 11, wherein at least one of said at least two outrigger sensors is located proximate to said azimuthal detector.

14. A system for determining a location of a cell phone within a campus, comprising:
a. a plurality of interferometers, each of said plurality of interferometers at least for detecting an azimuthal direction of a cell phone signal originating from the cell phone;
b. a location server in communication with each of said plurality of interferometers, said location server at least for determining the location of the cell phone from said azimuthal directions from each of said plurality of interferometers.
